(19) United States
(12) Patent Application Publication
(10) Pub. No.: US 2024/0410735 A1
(43) Pub. Date: Dec. 12, 2024

(54) SMART FUEL GAS CYLINDER REGULATOR

(71) Applicants: Liji Huang, Santa Clara, CA (US); Chih-Chang Chen, Cupertino, CA (US)

(72) Inventors: Liji Huang, Santa Clara, CA (US); Chih-Chang Chen, Cupertino, CA (US)

(73) Assignee: SIVELA TECHNOLOGY, INC., Santa Clara, CA (US)

(21) Appl. No.: 18/207,317

(22) Filed: Jun. 8, 2023

(51) Int. Cl. G01F 15/063; G01F 15/075; G01F 15/14

(52) U.S. Cl. CPC G01F 15/063; G01F 15/0755; G01F 15/14

(57) ABSTRACT

The disclosed apparatus is a fuel gas cylinder regulator which presents a new integrated device that consists of a microfabricated MEMS mass flow sensor, a low energy Bluetooth module, a standard pressure regulator, and an electric powered shutoff valve. The apparatus is capable of wireless data communication, and long-distance communication as well. The electric operated shutoff valve can spontaneously shut off the fuel gas supply once gas leakage or gas passage clog occurs. The apparatus can record and transmit the fuel gas consumption data to the suppliers or third-party service providers. It can also track and report the cylinder status, such as leakage and location, which can significantly enhance the efficiency and safety of fuel gas utilization and distribution logistics.

### BACKGROUND OF THE INVENTION

### 1. Field of the Invention

This invented disclosure presents an apparatus with functions of flow measurement and pressure regulating for fuel gas cylinder by combining components of a micro-electro-mechanical system (MEMS) mass flow sensor, a conventional mechanical regulator, a low energy Bluetooth module and an electric powered shutoff valve. The apparatus can monitor the fuel gas flow rate and usage for fuel tanks or fuel cylinders, which also connects to the internet and transmits the data to a cloud computing center for easier logistic management and lower costs.

### 2. Description of the Related Art

Many governments in the world have committed to promote clean fuels via pipelines for city energy, but there are still many places that rely on fuel gas cylinders for energy supply. This is because clean energy like natural gas may not be accessible everywhere, and pipeline construction may be too expensive especially in some remote areas with low population. As a result, millions of fuel cylinders are delivered daily worldwide. However, these fuel cylinders only have a mechanical pressure regulator to ensure safe fuel gas consumption. There are no devices to measure the actual gas consumption, monitor the gas leakage safety, or manage the logistics at the cylinder level. The customers are often responsible for refilling the cylinder and can only guess the consumption level. Customers may run out of gas unexpectedly because they cannot estimate their usage accurately. Some companies have educated their customers to use hot water and touch the cylinder surface to feel the gas level, as the gas would make the surface temperature different. Sometimes the customers may also shake the cylinder and listen to the sound to guess how much gas is left. These methods are not only unreliable but also unsafe.

John J. White (J. John, Tank Level Alarm Control System, U.S. Pat. No. 4,924,703, May 15, 190) disclose A gauge and alarm system for a tank that consists of two tubes: one fixed and sealed at the bottom, and one movable inside the first one. A float with a magnet surrounds the fixed tube and moves up and down with the liquid level. Another magnet is attached to the bottom of the movable tube, which follows the float. When the liquid reaches a certain high level, a small magnet inside the movable tube triggers a switch in an alarm box on top of the fixed tube. Bouvier (D. Bouvier, gas bottle with an alarm device, EP1843078A1, Oct. 10, 2007) describes a device that uses a float with a valve attached inside the gas cylinder to measure the level of liquid petroleum gas. Duenas (Roy A., Method and system for measuring and remotely reporting the liquid level of tanks and the usage thereof, U.S. Pat. No. 6,336,362, Jan. 8, 2002) disclose that a system and a method that remotely measure and report the amount of liquid propane in various tanks to a host system at the supplier's site or facility. This can help to avoid running out of gas, improve safety and reduce liability, plan and schedule refills, monitor propane usage and billing, track tank service and refill history, and manage propane inventory and purchasing. All three devices described above are entirely mechanical and has a large measurement error when the gas level is low. It is either not convenient to use because the user has to check the indicator often, and the low accuracy can affect the fuel price tremendously. Also, it cannot detect the gas phase that becomes more critical when the cylinder is half-empty. Humphery (R. L. Humphery, Apparatus for monitoring fluid levels in a remotely located storage tanks, U.S. Pat. No. 7,937,215, May 3, 2011) shows a mechanical shaft with a dialing gauge and a magnet that sends the signal of a float level inside the liquid gas cylinder. This disclosure solved the signal transmission issue but had the same problem of a mechanical float that needs the cylinder to be perfectly leveled. Otherwise, the gas consumption can be wrong depending on the level and the float position. Both disclosures also need a special cylinder with a float inside that is costly and fragile for a high volume application.

Peter Lagergren (Peter, Ultrasonic fuel level monitoring system incorporating an acoustic lens. US Patent Publication 20090025474, Jan. 29, 2009) disclosed a system for measuring the liquid level in a tank using ultrasound has a transducer unit that can be attached to the tank. The unit sends an ultrasonic beam through the tank wall and receives its reflection from the liquid surface. An acoustic lens between the unit and the tank wall shapes the ultrasonic beam to correct for the distortion caused by the tank wall. Another approach with a special cylinder with an acoustic level sensor inside (Olah, L., Acoustic liquid level detection, US Patent Applications, 2012/0031182, Feb. 9, 2012) has similar problems with accuracy, cost, and external devices. Suman (S. Suman, Propane tank continuous monitoring system, U.S. Pat. No. 9,851,053, Dec. 26, 2017) shows a system using a load sensor to monitor the propane gas consumption from a cylinder. The load sensor acts as a scale and needs close contact with the cylinder. The gas consumption is calculated based on the weight loss of the cylinder. But this needs a clear knowledge of the empty and full cylinder weights that may vary for different cylinders from different manufacturers. Also, any changes in the gas density and improper contact of the cylinder with the load sensor would cause errors. Moreover, the load sensor has a small dynamic range and cannot measure the liquid-gas phase inside a cylinder.

Mashburn (Nicholas, Monitoring and reporting a liquid level of a commodity in a tank, U.S. Pat. No. 9,911,095, Mar. 6, 2018) demonstrate a device to measure liquid level in a container by Hall Effect sensor. The system for tracking and reporting the liquid level of a product in a tank involves using a tank meter to measure the product level and sending the data to a server. A user can check the product level on a device and see if it is low. A supplier of the product can get an alert when the tank level is low. The tank location can be used to plan a future delivery of the product to one or more tanks. Although the system can measure the remaining liquid in the tank more precisely than the mechanical float, however, it is impractical to implant the Hall Effect Sensor into a high pressurized fuel cylinder. Wise (E. C., Method and apparatus for monitoring, communicating and analyzing the amount of fluid in a tank. U.S. Pat. No. 9,435,675, Sep. 6, 2016) shows a special device to monitor the remaining mass of a gas container. The device uses a flow meter to measure different flow rates that change when dispensing gas, and an embedded processor to determine the remaining mass and an indication. However, the device for the gas consumption is based on the rolling mean or average of several non-continuous measured flow rates that may be different from the actual mass as it also needs the knowledge of the gas density, pressure, and temperature. The device can be remotely connected to a system with a robot and a software application for remote gas data management. But this only helps the logistics of the gas bottles or cylinders, not the actual user(s) who have to be near the gas containers to know their status. This does not provide enough benefits for the actual user(s). Also, this device is an extra unit that may have safety risks if attached directly to the high pressurized gas container. Each pressurized gas container needs a dual durable mechanical pressure gauge and a pressure regulation mechanical valve that ensures safe gas release. Attaching the gas regulation valve before or after the device adds an extra part that makes it inconvenient to operate. The device also needs an external power source that adds more operational difficulties. This is especially unwanted for many residential applications.

### SUMMARY OF THE INVENTION

The present disclosure aims to design an apparatus that can instantly inform both the users and the suppliers of fuel gas cylinders about the fuel consumption and cylinder status. The apparatus can also detect and alert any leakage or safety issues to the users and the suppliers. The apparatus can significantly improve the usage of fuel gas cylinders to be more safe and efficient. The apparatus can measure the fuel consumption data directly and accurately without needing extra information or calculation. Moreover, the benefits of this scheme prevail over the reasonable and marketable cost.

For residential fuel cylinders, the apparatus can replace the current mechanical regulator without extra parts for the users. The apparatus can enhance the system's features, especially the features regarding the safety and convenience. The apparatus can also wirelessly interact with smart devices like phones that the users can access anytime. The smart devices can send the data to the cloud that can be shared with the fuel cylinder suppliers for managing inventory and production.

The apparatus in this disclosure can replace the current LPG (liquefied petroleum gas) fuel cylinder regulator, and LPG is one of the most popular fuel gases for household usage. Fuel gas in cylinders requires a simple mechanical pressure regulating device to drop the outlet pressure from the fuel gas cylinder to slightly more than the atmosphere pressure, which is the only thing required to use fuel gas cylinders for cooking ware appliances in many households of most developing countries.
Considering the actual application situations, the invented apparatus should not be an extra or separate unit, even though it enhances convenience and safety, since many users may not have the necessary knowledge for how to connect and maintain of the new apparatus. This apparatus should have the same mechanical connections as the conventional fuel gas cylinder pressure regulator.

In one preferred embodiment, the smart feature that adds to the current conventional pressure regulator is having a microfabricated MEMS mass flow sensor to measure the fuel gas consumption. The MEMS mass flow sensor is made by a micromachining technology like silicon CMOS technology. The micromachining technology uses thin film deposition, photolithography, and etching process, which are similar to a standard semiconductor process, to make micro-devices in a micron or sub-micron scale. The MEMS mass flow sensor chip in the current invention works based on calorimetric thermal mass flow sensing principle. The MEMS mass flow sensor is a battery-powered device that can measure the fuel gas consumption independently of the end-users' appliances. It does not need extra sensors for temperature and pressure measurement to calculate the total mass of the fuel gas due to its nature as measuring the mass flow rate. One central control circuit board in the apparatus is used to drive and control the MEMS mass flow sensor, which also has a flash memory that records the cumulative fuel gas consumption and can be set to send an alert when a certain limit is reached. The user or the supplier can access this information at any time. The MEMS mass flow sensor will switch to a low-power mode when the fuel gas is off to save battery life.

The MEMS mass flow sensor will be installed at the end of the pressure regulator before it connects to the external appliances. By this way, the device and the pressure regulator will form a single unit that will not affect the end-user's normal use of the fuel cylinders. A cylindrical assembly with several concentric cylinders that will form the scalable molded flow channels for flow measurement. The MEMS flow sensor will be at the center of the innermost cylinder since the sensor will have the highest sensitivity. The number of concentric cylinders can be adjusted according to the maximum flow rate needed. This design will allow the MEMS mass flow sensor to fit different gas regulators and gas bottles or cylinders for different applications. The full scale of the mass flow measurement range can be changed easily and economically by modifying the sensor assembly, which will also simplify the inventory management for different fuel gas cylinder sizes. The scalable molded flow channel, the conventional mechanical regulator and the central control circuit board with the battery will be enclosed in a housing compartment that will meet the safety standards for the fuel gas cylinders. The housing compartment will have the same inlet and outlet as the current conventional pressure regulators.

In another preferred embodiment, the disclosed apparatus can be easily connected to any fuel gas cylinders or tanks by matching the integrated regulator with them. The apparatus can also be used in other applications where there is a fixed gas source or a gas generator instead of a fuel gas cylinder or tank. In this case, the MEMS mass flow sensor can be separated from the pressure regulator and connected directly to the gas supply channel or pipeline.

In another preferred embodiment, the apparatus will also have a low-energy wireless communication component, such as Bluetooth or NB-IoT (narrowband Internet of Things), which can enable the gas consumption data to be easily transmitted to smart devices like a smart phone or a tablet that the users can access. The user can use a software or an APP on the smart device to log and analyze the gas consumption data and get feedback on the fuel gas level in the cylinder. The APP on the smart devices can also send the cylinder location to the cloud center. If the smart device is not nearby, a GPS module can be added to the NB-IoT module to send the cylinder location directly to the cloud center. If the wireless communication fails, the data can also be downloaded to the smart devices through a wired data port, such as a USB port. The user can also program the MEMS mass flow sensor through the APP or the wired data port to customize some functions, such as setting a low limit for the gas consumption. The fuel gas cylinder manufacturer can use the data from the cloud center to manage their products and services more efficiently and effectively.

In another preferred embodiment, the electric powered shutoff valve is used to terminate the fuel gas supply once the MEMS mass flow sensor detects abnormal gas flow rates, which are out of pre-set flow rate ranges, occurred. If the flow rate is higher than the maximum pre-set value, it usually indicate the fuel gas line has a leakage, therefore the central control circuit board will send a command to the shutoff valve and turn off the fuel gas supply. On the contrary situation, if the MEMS mass flow sensor detects abnormal gas flow rate which is lower than the minimum pre-set value, it may indicate the fuel gas line having a clog. Therefore the apparatus will send out an alert to the fuel gas supplier through wireless communication and turn off the gas line through the shutoff valve.

The present disclosure provides a new design of an apparatus with an integrated flow meter and pressure regulator for fuel gas cylinders. This apparatus will be capable of continuously and precisely metering the fuel gas consumption while relaying such data to the user and further to the other interest parties such as fuel gas cylinder suppliers via a Cloud data infrastructure. These and other objectives of the present disclosure will become readily apparent upon further review of the following drawings and specifications. And additionally, for those with the knowledge of the art,

### BRIEF DESCRIPTIONS OF THE DRAWINGS

FIG. 1 is the explosive view of the disclosed smart fuel gas cylinder regulator including three major components: a microfabriced MEMS mass flow sensor, a gas pressure regulator and an electric powered shutoff.

FIG. 2A is the front view of the full assembled apparatus in this disclosure.

FIG. 2B is the back view of the full assembled apparatus in this disclosure.

FIG. 3 is the structural view of the flow sensing assembly where the microfabricated MEMS mass flow sensor on carrier printed circuit board (PCB) is placed at the center of the concentric cylinder channel.

FIG. 4A is the cross-section view of the scalable concentric flow channel cylinders, which is showing one size of the channels with numbers of the concentric cylinders.

FIG. 4B is the cross-section view of the scalable concentric flow channel cylinders, which showing different size of the channels with different numbers of the concentric cylinders.

FIG. 5 is an example of the fully assembled apparatus applied on a gas cylinder.

FIG. 6 is a schematic showing the component interactions in the fuel gas cylinder management system with cloud data processing.

### DETAILED DESCRIPTION OF THE PREFERRED EMBODIMENTS

In the current system of delivering fuel gas in cylinders, a pressure regulator is needed to lower the high pressure of the gas inside the cylinder so that it can be used by home appliances. However, the existing options for measuring gas consumption are not accurate or easy to install. They are not suitable for residential use, where users have different levels of skill and comfort with handling devices. The ideal device should be simple and compatible with the existing pressure regulators. It should also have extra safety features for the benefits of users. Moreover, it should allow both the user and the supplier to access the gas consumption data, which can help improve inventory, storage, delivery and production of fuel gas cylinders. This disclosure aims to address these and other related needs for fuel gas cylinders. In the preferred embodiment, this disclosure presents a device that uses a MEMS mass flow sensor to measure the instant gas consumption and monitor the cylinder status accurately and continuously. The device also sends the data to both users via smart devices and suppliers via cloud data.

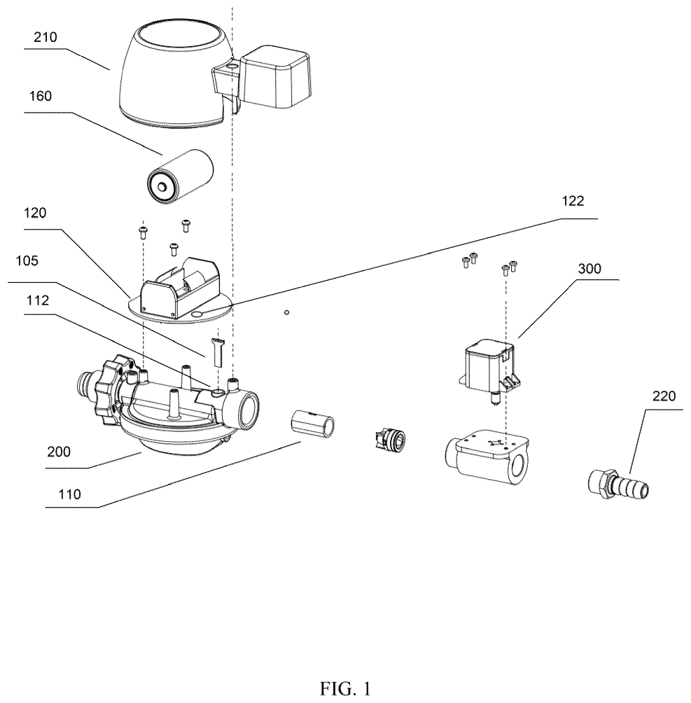

The explosive view of the integrated apparatus is shown in FIG. 1, where each component of the apparatus is disclosed. For the integrated apparatus, the pressure regulator 200 will be remained intact mostly except for adding a housing compartment 112 for the MEMS mass flow sensor on a carrier printed circuit board (PCB) 105. This house compartment combined with the pressure regulator housing is made by a metal casting process to become a single unit. The flow channel 110 is made by a plastic injection process using engineering plastics such like fiber-reinforced plastics. The flow channel will have an internal flow conditioner and flow profiler that will perform to stabilize the gas flow and enhance measurement accuracy and repeatability. It will as well significantly reduce the metal machining cost and make the exchangeability possible. After the molded flow channel is engaged into the MEMS mass flow sensor housing compartment 112, carrier printed circuit board 105 for the MEMS mass flow sensor can then be inserted into the opening on the sidewall of flow channel. The mechanical connector 220 to the appliances using fuel gas is a barbed nozzle which is a standard connector to the tubing for most appliances. 120 is the central control circuit board to drive and control the MEMS mass flow sensor, which contains the microcontroller unit (MCU) and signal conditioning circuitry using components such as analog to digital converter (ADC), operational amplifiers and other necessary electronics components. At least two physical memory chips such as e-flash are also included with direct access by the MCU for data storage and data security. A physical data port 122 in the form of a micro-USB or mini-USB or USB-C is also included for access to the data onboard in case the wireless data access is disabled or not readily accessible. 210 is the cover of the central control circuit board and the battery 160 to provide the necessary protection of the electronics from dust and moisture. This cover is secured onto the top structure of the pressure regulator 200 with screws. This circuitry also have the function of monitoring the battery 160 power status and will trigger a power failure warning once the remaining power of the battery is less than 20%. This power level is also programmable for specific applications, and the low power alerts will be provided accordingly. A wireless module on the control circuit board provides the data communication capability. The wireless module is an exchangeable component depending on the local authority regulation or network availability. In one preferred embodiment, the module contains both a low energy Bluetooth (BTLE) module and a longer distance wireless data module which can be selected from the options of NB-IoT, LoRa, WIFI, Sigfox. The BTLE module is used to broadcast the fuel gas cylinder regulator status with the smart devices of nearby users while the other wireless modules will be used to communicate with some remote data centers or designated Cloud servers. The battery 160 which is preferred to be a lithium-ion battery with a high capacity of at least 9 Ah for usage of over two years is used to provide the power for the MEMS mass flow sensor and the central control circuit board. Alternatively, the power can be supplied as well by two alkaline batteries which are easier to be acquired but will need to be replaced more frequently depending on the actual usage. These above components are then enclosed with the cover 210 which is preferred to be made of aluminum alloy for the sturdy protection of the entire apparatus and be consistent with the materials of the pressure regulators. Alternatively, the cover 210 can also be made of engineering plastics with impact absorbents. In order to have better resistance to rush environmental conditions, additional gaskets can be applied between the cover and the pressure regulator. The electric powered shutoff valve 300 was controlled by the central control circuit board. The shutoff valve 300 will be closed once the mass flow rate of fuel gas is out of the control range. When the mass flow rate is higher than the up limit, in most cases, it means the gas line has a leakage. In order to prevent the explosion hazards to happen, the central control circuit board will send out an emergency command to close the shutoff valve. On the other hand, if the mass flow sensor senses a very low mass flow rate, the central control circuit board will also close the shutoff valve and send out an alert to the user or the data center because the gas line may have a clog to cause the low flow.

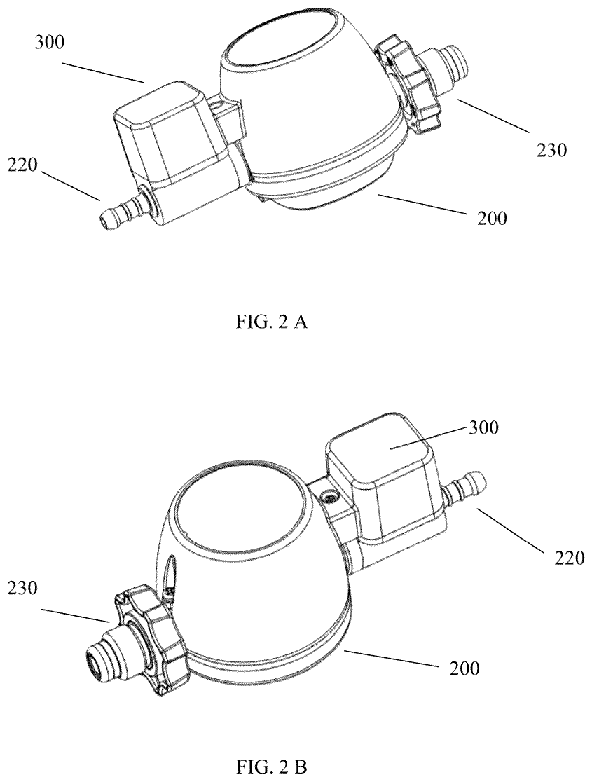

FIG. 2A and FIG. 2B exhibit the front and back view of the fully assembled apparatus as a new smart regulator for fuel gas cylinders. Component 230 is used as a mechanical connector to the gas exit of the fuel gas cylinder. In the preferred embodiment, the apparatus will be operated by the battery power, and it will continuously and precisely measure the instant mass flow rate of the fuel gas through the MEMS mass flow sensor while totalizing the accumulated amount of consumed fuel gas. The measured data will be stored efficiently in a plurality of physical memory chips for data security matter. The collected data can be relayed to a smart device via the Bluetooth wireless communication for the user with pre-set schedules or whenever the data requesting command is triggered. In one preferred embodiment, the data received by the smart devices will be further uploaded seamlessly to the designated Cloud or data center via the smart device network, which will be accessible by the fuel gas cylinder suppliers. In another embodiment, in case the user's smart device does not have network access, or the user does not possess an enabled smart device, the long-distance wireless module will be triggered to upload the collected data to the data center or the designated Cloud. Once any alerts are received by the data center, the received information will be spontaneously relayed to the users with preferred ways of communication such like text message or email account. The measurement items can be programmed such as total fuel gas consumption limit, maximum and minimal gas flow rates, and the lasting time of gas consumption. In a preferred embodiment, the measurement items that can be programmed via user's smart devices may be limited at the data center.

For the preferred embodiments, the flow measurement component will have a molded scalable flow channel where the MEMS mass flow sensor can be inserted inside the center of the flow measurement component. This component can then be installed directly to a molded metal compartment without additional process or machining.

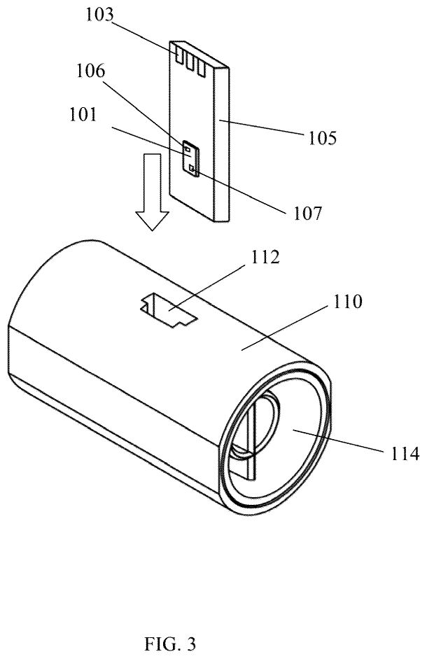

FIG. 3 shows the schematic exhibition of these two parts of the flow measurement component. The MEMS mass flow sensor chip 101 is placed at the bottom center on the carrier printed circuitry board (PCB) 105. A pressure sensor 106 and a temperature sensor 107 are integrated in the same MEMS mass flow sensor chip. And the wire bonding pads 103 is located on the upper portion of the carrier PCB 105. The MEMS mass flow sensor utilizes calorimetric or time-of-flight thermal mass flow sensing principle as disclosed. In the preferred embodiment, the MEMS mass flow sensor is operated with the calorimetric mass flow sensing which is able to directly measure the fuel gas mass flow rate with no need for the parameters of pressure and temperature for calculation the mass flow rate. The pressure sensor 106 integrated on the MEMS flow sensor chip is used to monitor the fuel gas pressure in the supply line to the residential appliances, the regulated pressure must be in the required ranges otherwise the appliances will either not work properly or lead to safety issues. The additional monitoring of the pressure data combined with the flow rate measurement could also be used for the detection of fuel leakage that will not only cause a waste of the fuel gas but also lead to a severe safety issue.

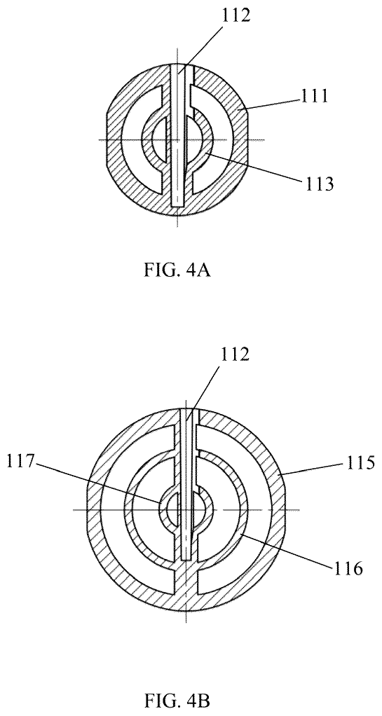

FIG. 4A and FIG. 4B exhibit the cross-section of the molded scalable flow channel configurations wherein the flow channel is partitioned by several concentric cylinders. The flow measurement, the pressure and the temperature sensing elements are placed at the center of the cylinders to achieve best sensitivity. This configuration provides a more stable flow and ensures higher measurement accuracy. The partition of the flow channel is preferred for flow channel size larger than 5 mm in diameter. As shown of a preferred embodiment in the FIG. 4A, two concentric cylinders will be needed for a flow channel size of 8 mm. And for a flow channel size of 12 mm shown in the FIG. 4B, 3 concentric cylinders will be required. When there are more than 2 concentric cylinders, the space between any two cylinders is preferred to be equal. The outer cylinder (111 and 115) in both configurations of 2 or 3 cylinders is preferably to have a thicker wall while the inner cylinders (113, 116, and 117) are preferred to have thinner walls. The thickness of the inner cylinder walls is preferred to be within 1 mm. The sensing element carrier PCB will be installed inside the housing compartment 112 where the sensing elements will be located at the center of the cylinders.

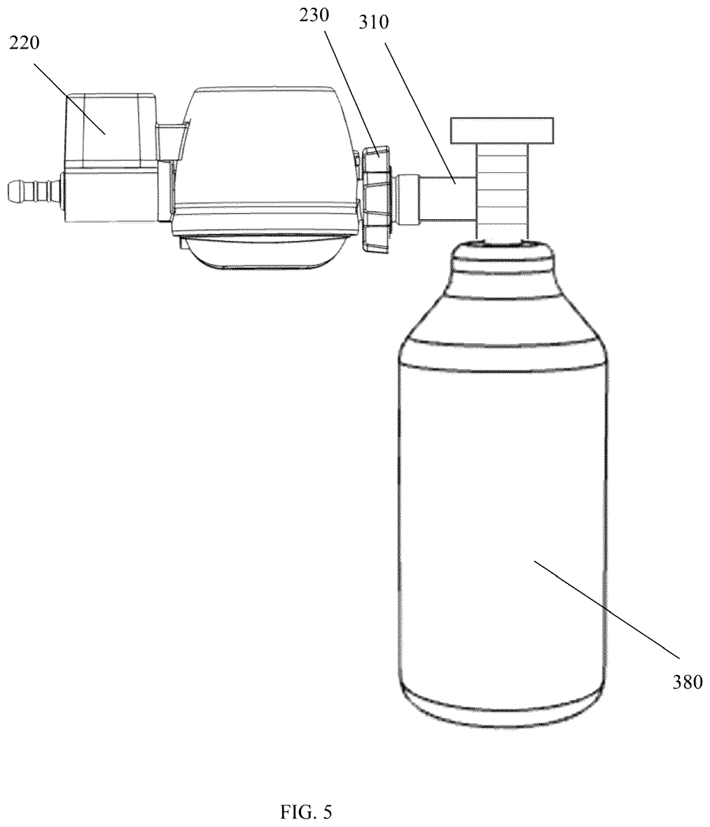

The advantages of the preferred embodiment are illustrated in FIG. 5, which is a typical installation of the apparatus on a fuel gas cylinder. In the preferred embodiment, the disclosed apparatus is connected to the fuel gas cylinder 380 via the standard connector 310 on the cylinder that will be engaged tightly with the connector on the apparatus 230. And the barbed nozzle connector 220 is identical to those of the existing conventional mechanical pressure regulators. This installation procedure will be exactly the same as that with a pure pressure regulator gauge. Therefore there is no requirement of additional training needed for the installation of the apparatus compared to convention pressure regulator. As the apparatus will deliver battery low power alerts to the users as well as to the designated data center, timely service of battery change can be guaranteed. In the worst scenario that the battery loses its power abruptly, it will not affect the usage of the fuel gas as the installed shutoff valve is a normally close valve. However, the loss of communication with the data center will lead to a prompt attention for the data center to recover the power failure.

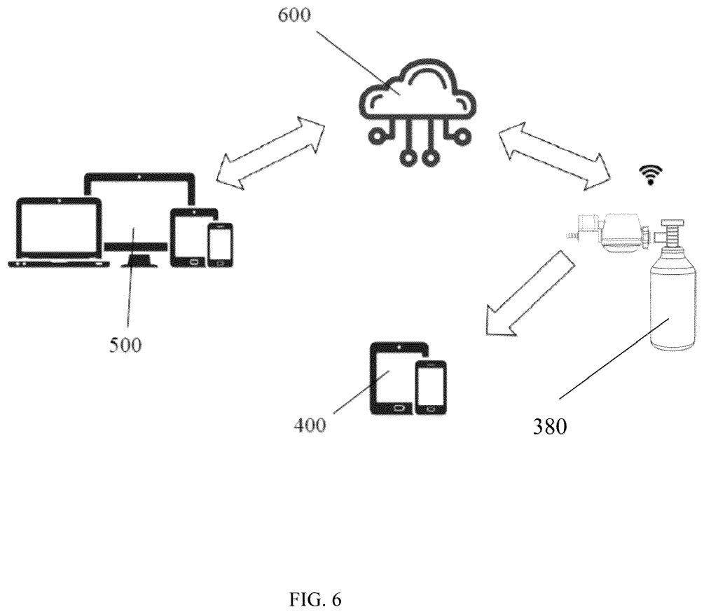

For the preferred embodiment, the interaction scheme among the apparatus installed onto a fuel gas cylinder, the users with the smart devices, the Cloud with the data process, and the third parties such as fuel gas cylinder suppliers or service providers are illustrated in FIG. 6. The apparatus engaged with the fuel gas cylinder 380 can be a single unit or multiple units, and wherein each unit will have a unique digital address with a preferred communication module or protocol to meet the specific local requirements. Each of the apparatus will then communicate via Bluetooth to the smart device 400 to broadcast the fuel gas consumption data and fuel gas cylinder status data such as leakage and alarms. In one preferred embodiment, the apparatus can also be communicating with a nearby WIFI or a LoRa or other wireless protocols to alert the fuel gas cylinder users and relay the data to the designated data center to the Cloud 600 for data process. The communication module for the disclosed apparatus can be as well a direct cloud data transmission module such as an NB-IoT module which is a dual-module configuration that is combining the local data relay. This communication module can also provide the cylinder location information along with the cylinder IDs to the cloud. Alternatively a OPS module can also be added to the apparatus for additional location identification. The interactions between the apparatus and the local user or a smart device are preferred to be unidirectional for preventing from user tampering or unintentional interference with the apparatus. Additionally, a web-enabled passcode or a security password can allow smart devices of users to access the apparatus. The interactions between the apparatus and the Cloud data center is preferably to be bidirectional, and wherein the apparatus will also be able to accept the commands for modifying parameter settings and uploading the fuel gas consumption as the fuel gas cylinder status from the remote data center. The interactions between the Cloud 600 and the fuel gas cylinder suppliers or service providers 500 is also preferred to be bidirectional, which will allow the suppliers or service providers to upload the information to the Cloud, and the Cloud can distribute the received information to the designated fuel gas cylinders. Finally, users, suppliers, and third-party service providers will also be able to interact with the apparatus via either the Cloud or an APP on the smart devices for various executable actions as being disclosed in the previous embodiments.

For the additional preferred embodiments, the apparatus for those in the art shall become readily and apparently could be further incorporated with additional features and deploy the invented apparatus to other applications such as industrial gas cylinder usage. While the invention has been described in terms of what are presently considered to be the most practical and preferred embodiments, it is to be understood that the invention need not be limited to the disclosed embodiments. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims

1. A smart fuel gas cylinder regulator comprising:
a microfabricated Micro-Electro-Mechanical System (MEMS) mass flow sensor;
a molded scalable flow channel with concentric cylinders;
a mechanical pressure regulator;
an electric powered shutoff valve;
a central control circuit board;
a lithium ion battery; and
a housing compartment for the microfabricated MEMS mass flow sensor carrier PCB;
wherein the central control circuit board includes
a low energy Bluetooth device;
a long-range communication device; and
a physical data communication port;
wherein the MEMS mass flow sensor is operating with a calorimetric thermal mass flow sensing principle, and working with the central control circuit board to measure an fuel gas mass flowrate, wherein the MEMS mass flow sensor is placed at a center of the concentric cylinders inside the molded scalable flow channel;
wherein the electric operated shutoff valve will close fuel gas supply once the mass flowrate measured by the MEMS mass flow sensor are out of maximum and minimum ranges of set points;
wherein the low energy Bluetooth device that relays the fuel gas mass flowrate, a measured fuel gas consumption data, a fuel gas cylinder status, and a fuel gas cylinder location to a smart device which may or may not further relay the an information or to a designated data center;
wherein the molded scalable flow channel that re-partitions a gas flow via a plurality of concentric cylinders;
wherein the long-range communication device directly relays the fuel gas consumption data, the fuel gas cylinder status, and the fuel gas cylinder location to a designated data center;
wherein the physical data port is used to download the fuel gas consumption data and the cylinder status data, the physical data port is located inside the meter housing compartment and only can be accessed by fuel gas cylinder suppliers or third-party service providers; and
wherein the housing compartment to accommodate and enclose the carrier PCB mounted with the microfabricated MEMS mass flow sensor.

2. The smart fuel gas cylinder regulator of claim 1 wherein the mechanical pressure regulator are those regularly used for fuel gas cylinders on market, wherein pressure regulation structure and enclosure of the mechanical pressure regulator are not altered but a gas delivery barbed port is included as a hose connector to other appliances.

3. The smart fuel gas cylinder regulator of claim 1 wherein the MEMS mass flow sensor is integrated with a pressure sensor and a temperature sensor on a same substrate of the MEMS mass flow sensor wherein the pressure sensor will gauge delivered fuel gas pressure from the mechanical pressure regulator and the temperature sensor will alert abnormal operation temperature, wherein a pressure measurement data combined with a mass flow rates measurement data can be used to evaluate if there is a fuel gas leakage or a fuel gas clog in fuel gas line in order to timely shut off the fuel gas supply and alert users as well as the fuel gas cylinder suppliers for safety emergence purpose.

4. The smart fuel gas cylinder regulator of claim 1, wherein the central control circuit board is capable to process an acquired mass flow rate data into a digital format and further totalize consumed fuel gas mass in each usage session, wherein the central control circuit board can process the acquired instant mass flow rate data in a way instructed by the fuel gas cylinder suppliers or the third-party service providers via preset parameters, wherein the central control circuit board is able to further drive the apparatus to communicate with other portable devices at proximity or allow the acquired data to be downloaded or uploaded, wherein the central control circuit further has a plurality of numbers of memory chips or devices that allow the acquired data can be simultaneously stored for data security purpose, and it also has other necessary functions such like password-protected access.

5. The smart fuel gas cylinder regulator of claim 1 wherein the low energy Bluetooth device will enable a low energy Bluetooth communication, an wireless antenna is placed inside of the housing compartment for safety and prevention of tampering, wherein the low energy Bluetooth communication relays the gas consumption data as well as the fuel gas cylinder status to a paired smart device which can run an APP to further relays the acquired data from the apparatus to a designated data cloud center for data processing.

6. The smart fuel gas cylinder regulator of claim 1 wherein in case that there are no smart devices at proximity area, another long-distance wireless data transfer modules selected from protocols of NB-IoT, WIFI, LoRa or Sigfox can be integrated inside the apparatus, and one of them will relay the acquired data and cylinder status to the designated data center or the cloud for data processing, wherein in most cases, one of the above long-distance wireless data transfer modules together with the cylinder ID can provide cylinder geographical location data, wherein for additional security of the geographical location data, a GPS module can be combined into any one of those long-distance wireless data transfer modules.

7. The smart fuel gas cylinder regulator of claim 1 wherein the physical data port is used to manually download the fuel gas consumption data and the fuel gas cylinder status using a laptop computer or a smart phone, wherein the digital data devices can enable a wireless data transmission to the designated data cloud center, wherein the physical data port can be chosen from a group of ports including micro-USB, mini-USB or USB-C for easy accessibility.

8. The smart fuel gas cylinder regulator of claim 1 wherein the MEMS mass flow sensor is able to work at a low power mode and is powered by a high-capacity lithium-ion battery or a pack of plural number of alkaline batteries on market, wherein for case of using lithium-ion battery, a C-cell allows the apparatus to continuously work for two calendar years, for case of using alkaline batteries, a pack of minimal of 4 AA battery will allow continuous operation for one year.

9. The smart fuel gas cylinder regulator of claim 1 wherein the MEMS mass flow sensor is able to be independently calibrated, wherein the scalable molded flow channel made with concentric cylinders is connected to an exit of the mechanical pressure regulator and deliver the fuel gas to appliances using the gas delivery barbed port, wherein outer wall of the concentric cylinder will have a thickness ranged from 1.5 mm to 3 mm, and inner wall of the concentric cylinder has a thickness ranged from 0.8 to 1.5 mm, wherein the molded scalable flow channel and the concentric cylinders are made of engineering plastics or aluminum alloy to be consistent with build of the mechanical pressure regulator, and to meet safety requirements of corresponding industrial standards.

10. The smart fuel gas cylinder regulator of claim 1 wherein an diameter of the molded scalable flow channel is originally 6 mm with one concentric cylinder, wherein the diameter of the flow channel becomes 8 mm by adding one concentric cylinder, and the diameter of the flow channel becomes 12 mm by adding two concentric cylinders.
